(19) United States
(12) Patent Application Publication
(10) Pub. No.: US 2026/0270210 A1
(43) Pub. Date: Sep. 10, 2026

(54) SYSTEMS AND METHODS FOR DEVICE-TO-DEVICE COMMUNICATIONS

(71) Applicant: ZTE CORPORATION, Shenzhen (CN)

(72) Inventors: Weiqiang DU, Shenzhen (CN); Wei LUO, Shenzhen (CN)

(73) Assignee: ZTE CORPORATION, Shenzhen (CN)

(21) Appl. No.: 19/660,932

(22) Filed: Apr. 28, 2026

Related U.S. Application Data
(63) Continuation of application No. PCT/CN2023/129429, filed on Nov. 2, 2023.

(51) Int. Cl. H04L 47/2483; H04W 28/02; H04W 92/18

(52) U.S. Cl. CPC H04L 47/2483; H04W 28/0252; H04W 92/18

(57) ABSTRACT

The present disclosure relates to sending, by a first wireless communication device to a network, communication information report of the first wireless communication device, receiving, by the first wireless communication device from the network, communication configuration; and communicating, by the first wireless communication device with a second wireless communication device according to the communication configuration.

### CROSS-REFERENCE TO RELATED APPLICATION

This application claims the benefit of priority under 35 U.S.C. § 120 as a continuation of International Patent Application No. PCT/CN2023/129429, filed on Nov. 2, 2023, the disclosure of which is incorporated herein by reference in its entirety.

### TECHNICAL FIELD

The disclosure relates generally to wireless communications and, more particularly, to device-to-device communications.

### BACKGROUND

Sidelink (SL) communication refers to wireless radio communication between two or more User Equipments (UEs). In this type of communications, two or more UEs that are geographically proximate to each other can communicate without being routed to a network (e.g., Base Station (BS)) or a core network. Data transmissions in SL communications are thus different from typical cellular network communications that include transmitting data to a network and receiving data from a network. In SL communications, data is transmitted directly from a source UE to a target UE through, for example the Unified Air Interface (e.g., PC5 interface) without passing through a network.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to sending, by a first wireless communication device to a network, communication information report of the first wireless communication device, receiving, by the first wireless communication device from the network, communication configuration; and communicating, by the first wireless communication device with a second wireless communication device according to the communication configuration.

Some arrangements of the present disclosure relate to systems, methods, apparatuses, and non-transitory computer-readable media relating to receiving, by a network from a first wireless communication device, communication information report, and sending, by the network to the first wireless communication device, communication configuration in response to receiving the communication information report. The first wireless communication device communicates with a second wireless communication device according to the communication configuration.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communications, according to various arrangements.

FIG. 3 is a process flowchart diagram illustrating an example method for reporting Quality of Service (QOS) flow TX profile, according to various arrangements.

FIG. 4 is a process flowchart diagram illustrating an example method for reporting QoS flow TX profile, according to various arrangements.

FIG. 5 is a diagram illustrating an example Multiple Consecutive Slot transmission (MCSt) resource with multiple slots and another example MCSt resource with multiple slots, according to various arrangements.

FIG. 6 is a diagram illustrating an example MCSt resource with multiple slots, according to various arrangements.

FIG. 7 is a diagram illustrating an example MCSt resource with multiple slots, an example MCSt resource with multiple slots, an example MCSt resource with multiple slots, and an example MCSt resource with multiple slots, according to various arrangements.

FIG. 8 is a flowchart diagram illustrating an example method for providing communication configuration, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In some arrangements, wireless communications can be performed on carriers, frequency bands, and/or frequency spectrums. Some carriers are licensed carriers as they are licensed by a government or another authoritative entity to a service provider for exclusive use. Some carriers are unlicensed carriers, which are not licensed by any government or authoritative entities for exclusive use. Two or more service providers may operate in an unlicensed carrier. Currently, UEs may communicate directly with each other (e.g., without doing so using a base station) on the licensed carriers. No schemes have been provided for UEs to communicate with each other on unlicensed carriers.

Device using, utilizing, and applying sidelink communication can support two resource modes (e.g., mode 1 and mode 2). For mode 1, a UE can use a resource scheduled by a network to transmit sidelink data. For mode 2, a UE can select a transmission resource by itself to transmit sidelink data.

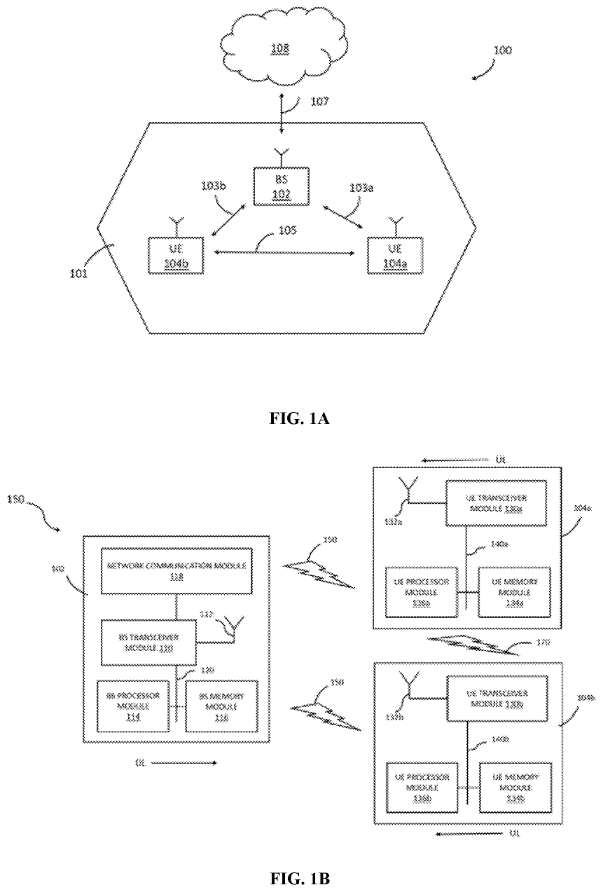

Referring to FIG. 1A, an example wireless communication network 100 is shown. The wireless communication network 100 illustrates a group communication within a cellular network. In a wireless communication system, a network side communication node or a network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a network 102 and UEs 104a and 104b, respectively. In some arrangements, the network 102 and UEs 104a/104b are sometimes referred to as “wireless communication node” and “wireless communication device,” respectively. Such communication nodes/devices can perform wireless communications.

In the illustrated arrangement of FIG. 1A, the network 102 can define a cell 101 in which the UEs 104a and 104b are located. The UEs 104a and/or 104b can be moving or remain stationary within a coverage of the cell 101. The UE 104a can communicate with the network 102 via a communication channel 103a. Similarly, the UE 104b can communicate with the network 102 via a communication channel 103b. In addition, the UEs 104a and 104b can communicate with each other via a communication channel 105. The communication channels 103a and 104b between a respective UE and the network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The network 102 is connected to Core Network (CN) 108 through an external interface 107, e.g., an Iu interface.

In some examples, a remote UE (e.g., the UE 104b) that does not directly communicate with the network 102 or the CN 108 (e.g., the communication channel link 103b is not established) communicates indirectly with the network 102 and the CN 108 using the SL communication channel 105 via a relay UE (e.g., the UE 104a), which can directly communicate with the network 102 and the CN 108 or indirectly communicate with the network 102 and the CN 108 via another relay UE that can directly communicate with the network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the network 102 and UEs 104a and 104b, as described in FIG. 1A. The network 102 includes a network transceiver module 110, a network antenna 112, a network memory module 116, a network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the network 102 is known as an uplink transmission, and a wireless transmission from an antenna of the network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the network transceiver module 110 may be herein referred to as a downlink transceiver, or network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the network 102 that enable bi-directional communication between network transceiver 110 and other network components and communication nodes configured to communication with the network 102. For example, the network interface 118 may be configured to support internet or WiMAX traffic. In a typical deployment, without limitation, the network interface 118 provides an 802.3 Ethernet interface such that network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the network 102 to communicate with other networks or core network over a wired or wireless connection.

In some arrangements, each of the UEs 104a and 104b can operate in a hybrid communication network in which the UE communicates with the network 102, and with other UEs, e.g., between 104a and 104b. As described in further detail below, the UEs 104a and 104b support SL communications with other UE's as well as downlink/uplink communications between the network 102 and the UEs 104a and 104b. In general, the SL communication allows the UEs 104a and 104b to establish a direct communication link with each other, or with other UEs from different cells, without requiring the network 102 to relay data between UEs.

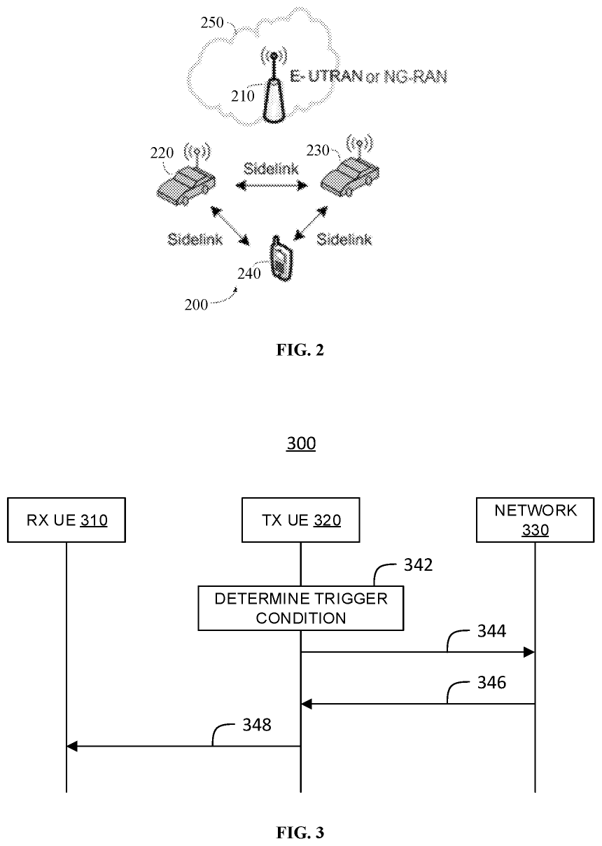

FIG. 2 is a diagram illustrating an example system 200 for SL communication, according to various arrangements. As shown in FIG. 2, a network 210 (such as network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

FIG. 3 is a process flowchart diagram illustrating an example method 300 for reporting Quality of Service (QOS) flow TX profile, according to various arrangements. The method 300 can be performed by the RX UE 310, the TX UE 320, and the network 330. An example of the RX UE 310 can be the UE 104a. An example of the TX UE 320 can be the UE 104b. An example of the network 330 can be the BS 102 and/or the CN 108.

At 342, the TX UE 320 determines a trigger condition for providing the D2D communication information. At 344, the TX UE 320 sends to the network 330 (e.g., the BS 102), and the network 330 receives from the TX UE 320, D2D communication information. The D2D communication information includes the TX profile. At 346, the network 330 (e.g., the BS 102) sends to the TX UE 320 and the TX UE 320 receives from the network 330 the D2D communication configuration. At 348, the TX UE 320 performs D2D communications with the RX UE 310 according to the D2D communication.

In some examples, the D2D communication information includes the TX profile and a QOS flow ID identifying a QoS flow of the TX UE 320. The QoS flow ID corresponds to, is associated with, or is mapped to the TX profile. In some examples, the TX profile includes an indication indicating whether the QoS flow ID is backward compatible or backward incompatible.

In some examples, D2D communication information (e.g., sidelinkUEinformation) includes at least one of destination layer2 ID (e.g., DST L2 ID), QOS flow ID, QoS profile associated to the QoS flow identified by the QoS flow, TX profile associated to the QoS flow identified by the QOS flow ID, requirement of legacy carrier associated to the DST L2 ID or QoS flow ID, parameters to request the transmission resources (e.g., frequency) for NR sidelink communications for the associated destination, and so on.

In some examples, when the higher layer (e.g., a V2X layer) provides multiple carriers-in-service-to-carrier mapping information to the Access Stratum (AS) layer, TX profile is used to indicate whether the transmission corresponding to the service type is backward compatible or backward incompatible. In the examples in which backward compatibility is needed, the TX UE uses only the legacy carrier without Packet Data Convergence Protocol (PDCP) duplication, or uses PDCP duplication with at least the legacy carrier.

In some examples, the trigger condition includes determining that a last transmission of a D2D communication information (e.g., a last transmission of the SidelinkUEInformationNR message) excludes or lacks a QOS flow ID and a frequency (e.g., a frequency range, a frequency resource, a Bandwidth Part, and so on) corresponding to the QoS flow ID. That is, in response to determining that the last transmission of the D2D communication information excludes or lacks a QOS flow ID and a frequency (e.g., a frequency range, a frequency resource, a Bandwidth Part, and so on) corresponding to the QoS flow ID, the communication information is sent at 344.

In some examples, the trigger condition includes determining that at least one upper layer configures the TX UE 320 to receive New Radio (NR) sidelink communication on a frequency included in a second carrier list (e.g., sl-FreqInfoListSizeExt) in a System Information Block (SIB) (e.g., SIB12) of a Primary Cell (PCell) and determining that since the last time that the TX UE 320 transmitted a D2D communication information (e.g., SidelinkUEInformationNR message), the TX UE 320 has connected to the PCell providing the SIB12 that does not include the second carrier list. That is, the communication information is sent at 344 in response to determining that at least one upper layer configures the TX UE 320 to receive NR sidelink communication on a frequency included in a second carrier list in a SIB of a PCell and determining that since the last time that the TX UE 320 transmitted a D2D communication information, the TX UE 320 has connected to the PCell providing the SIB that does not include the second carrier list.

In some examples, the trigger conditions includes determining that since the last transmission of the D2D communication information, the included QoS flow ID and corresponding frequency has changed. That is, in response to determining that since the last transmission of the (D2D) communication information, the included QoS flow ID and corresponding frequency has changed, the communication information is sent at 344.

In some examples, the trigger conditions includes determining that the TX UE 320 is configured by upper layers to receive or transmit D2D communication on the frequency included in second carrier list in system information of the PCell, and that since the last time the UE transmitted D2D communication information the UE connected to a PCell providing system information but not including the second carrier list. That is, in response to determining that the TX UE 320 is If configured by upper layers to receive or transmit D2D communication on the frequency included in second carrier list in system information of the PCell, and that since the last time the UE transmitted a device to device(D2D) communication information the UE connected to a PCell providing system information but not including the second carrier list, the communication information is sent at 344.

In some examples, system information (e.g., SIB12) can include two carrier list, a first carrier list and a second carrier list (e.g., sl-FreqInfoList, sl-FreqInfoListSizeExt). In some examples, the second carrier list may not be included in the system information.

In some arrangements a UE performs a channel access scheme referred to as Listen Before Talk (LBT) before performing data transmission on an unlicensed carrier. In the LBT procedure, the UE monitors a channel in the unlicensed carrier for an interval of time. In response to determining that the LBT procedure is successful, the UE can occupy the channel in the unlicensed carrier for an interval of time referred to as Channel Occupy Time (COT). The LBT procedure includes initial LBT procedure and non-initial LBT procedure. Compared to the non-initial LBT, the UE needs more time to perform the initial LBT procedure. The non-initial LBT procedure is performed within the COT.

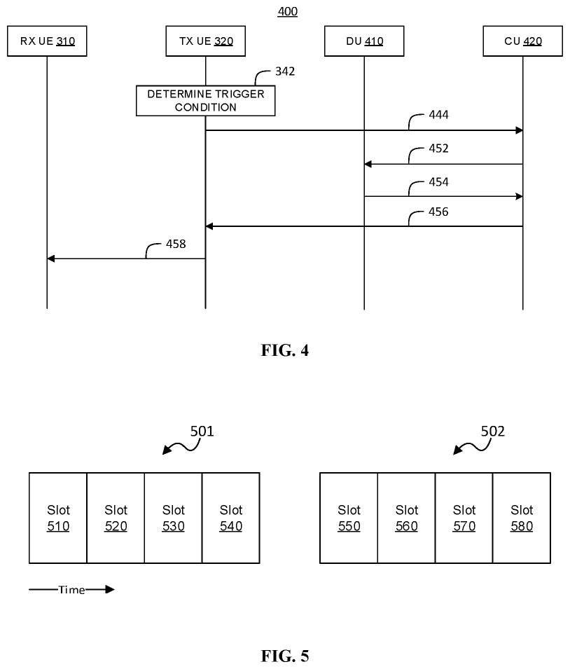

FIG. 4 is a process flowchart diagram illustrating an example method 400 for setting configuration for D2D RB in F1 interface, according to various arrangements. The method 400 can be performed by the RX UE 310, the TX UE 320, a Distributed Unit (DU) 410, and a Centralized Unit (CU) 420. The network 330 (e.g., the BS 102 and/or the CN 108) can include the DU 410 and the CU 420.

At 342, the TX UE 320 determines the trigger condition for providing the D2D communication information of the TX UE 320 in the manner described. At 444, the TX UE 320 sends to the CU 420, and the CU 420 receives from the TX UE 320, the D2D communication information. The D2D communication information includes the TX profile and a QoS flow ID identifying a QoS flow of the TX UE 320. The QoS flow ID corresponds to, is associated with, or is mapped to the TX profile.

In some examples, D2D communication information (e.g., sidelinkUEinformation) includes at least one of destination layer2 ID (e.g., DST L2 ID), QOS flow ID, QoS profile associated to the QOS flow identified by the QoS flow ID, TX profile associated to the QoS flow identified by the QoS flow ID, requirement of legacy carrier associated to the destination identified by DST L2 ID or QoS flow identified by QoS flow ID, D2D frequency associated to the QoS flow identified by the QoS flow ID, parameters to request the transmission resources (e.g., frequency) for NR sidelink communications for the associated destination, and so on.

At 452, the CU 420 sends to the DU 410, and the DU 410 receives from the CU 420 a UE context request (e.g., UE CONTEXT SETUP REQUEST or UE CONTEXT MODIFICATION REQUEST).

The UE context request includes at least one of D2D communication information reported by UE (e.g., TX UE), or UE ID(e.g., ID of TX UE), peer UE ID (e.g., ID of RX UE), D2D Radio Bearer (RB) establish (or setup or modify) request.

The D2D Radio Bearer (RB) establish (or setup or modify) request includes at least one of D2D RB ID, QOS flow ID identifying the QoS flow mapped to this D2D RB, duplication configuration.

In some examples, the duplication configuration includes at least one of an indication of whether duplication is enabled or disabled or an indication of whether duplication is configured or not configured, D2D communication information is reported by the UE identified by UE ID. For example, the duplication configuration can include a first value of a first indication indicating that duplication is enabled(e.g., value true) and a second value of the first indication indicating that duplication is disabled (e.g., value false). For example, the duplication configuration can include a first value of a first indication indicating that duplication is configured (e.g., value true) and a second value of the first indication indicating that duplication is not configured (e.g., value false). In some examples, duplication configuration is used for PDCP duplication for device to device communication(e.g., communication between TX UE and RX UE). In response to determining that duplication is enabled or configured, two RLC channels or bearers are associated to one PDCP entity for one D2D RB. Therefore, except the legacy one RLC channel, an additional RLC channel is needed for PDCP duplication.

At 454, the DU 410 sends to the CU 420, and the CU 420 receives from the DU 410, a UE context response(e.g., UE CONTEXT SETUP RESPONSE or UE CONTEXT MODIFICATION RESPONSE).

The UE context response includes at least one of UE ID (e.g., ID of TX UE), peer UE ID (e.g., ID of RX UE), D2D communication configuration for this UE identified by the UE ID.

The D2D communication configuration includes D2D Radio Bearer (RB) establish (or setup or modify) response.

D2D RB establish (or setup or modify) response including D2D RB ID, RLC bearer(e.g., RLC channel) configurations for two Radio Link Control (RLC) channels associated to one D2D radio bearer, the RLC bearer or channel configuration includes configurations for a first RLC channel and the additional RLC channel. That is, the TX UE 320 is configured with two RLC channels for one D2D radio bearer.

The RLC bearer configuration includes at least one of served RB ID identifying the RB to which the RLC bearer is associated, allowed carrier list including the carrier on which the data of RLC bearer (or the LCH mapped to the radio bearer) is allowed to be transmitted.

Examples of a peer UE ID can include Cell Radio Network Temporary Identifier (C-RNTI), DST L2 ID, DST ID Index, and so on. Examples of the UE ID can include gNB-CU UE F1AP ID, gNB-DU UE F1AP ID, C-RNTI, and so on. In some examples, upon receiving the duplication configuration including indication of duplication is enabled or configured(e.g., value true) for the D2D radio bearer, the DU 410 setups two RLC channels or bearers for the D2D radio bearer. In some examples, upon receiving the duplication configuration including indication duplication is disabled or not configured(e.g., value false) for the D2D radio bearer, the DU 410 release additional RLC channels (e.g., second RLC channel) or bearers for the D2D radio bearer. In response to release the additional RLC channel, the RLC bearer (e.g., RLC channel) configurations included in the UE context response includes only one RLC bearer associate to one RB. In some examples, upon receiving the duplication configuration of the D2D radio bearer (e.g., sidelink SRB), the DU 410 setups at least two carriers for the indicated UE.

In some example, the DU 410 sends to the CU 420, and the CU 420 receives from the DU 410, a UE context request(e.g., UE CONTEXT MODIFICATION REQUIRED). UE context request includes the D2D communication configuration.

In some example, the DU 410 sends to the CU 420, and the CU 420 receives from the DU 410, a UE context response(e.g., UE CONTEXT MODIFICATION CONFIRM).

At 456, the CU 420 sends to the TX UE 320 and the TX UE 320 receives from the CU 420 the D2D communication configuration. D2D communication configuration includes at least one of D2D RB ID (e.g., sidelink radio bearer configuration index), the D2D communication configuration received from DU, the PDCP configuration associated to the D2D RB identified by the D2D RB ID. D2D communication configuration includes the two Radio Link Control (RLC) channels for one D2D radio bearer, including configurations for a legacy RLC channel and the additional RLC channel. At 458, the TX UE 320 sends the D2D communication configuration to RX UE and performs D2D communications with the RX UE 310 according to the D2D communication configuration (e.g., according to the additional RLC channel configuration). That is, the TX UE 320 applies the received D2D communication configuration, establish two RLC bearer(e.g., legacy RLC bearer and additional RLC bearer) for a radio bearer with RX UE and sends D2D communication using two Radio Link Control (RLC) channels for one D2D radio bearer.

In some examples, the duplication is PDCP duplication. In the examples in which duplication is enabled for a radio bearer, one PDCP entity can be associated to one RLC bearer (e.g., a first RLC bearer) and an additional RLC bearer (e.g., second RLC bearer), or one PDCP entity is associated to two RLC bearers. The TX UE 320 can submit the PDCP packet to either one RLC bearer or additional RLC bearer. The TX UE 320 can duplicate the PDCP packet and submit the duplicated packet to both one RLC bearer and additional RLC bearer.

In some arrangements, the D2D RB establish (or setup or modification) request (transmitted from CU to DU) is included in at least one of a UE CONTEXT SETUP REQUEST or UE CONTEXT MODIFICATION REQUEST.

In some arrangements, the D2D RB establish (or setup or modification) response(transmitted from DU to CU) is included in at least one of a UE CONTEXT SETUP RESPONSE or UE CONTEXT MODIFICATION RESPONSE.

In some arrangements, radio bearer includes sidelink data radio bearer, sidelink signaling radio bearer, and so on. In some arrangements, CU sends the D2D communication configuration to TX UE 320. In some arrangements, the TX UE 320 sends the D2D communication configuration to the RX UE 310. In the examples in which two RLC bearers are associated to one radio bearer included in D2D communication configuration, the RX UE 310 establishes two RLC bearers associated to one radio bearer.

In some examples, the TX UE 320 performs D2D communication with RX UE 310 via a carrier and detects carrier failure on a carrier. The TX UE 310 detects the carrier failure in response to determining at least one of the Channel Busy Ratio (CBR) of the carrier is greater than a configured CBR threshold, the number of absent of Physical Sidelink Feedback Channel (PSFCH) reception reaches or exceeds the configured maximum value.

In some examples, the TX UE 310 can detect carrier failure. For example, in response to determining that PSFCH reception is not detected or is absent on the PSFCH reception occasion, the TX UE 310 increments a counter numConsecutiveDTX by 1. In response to determining that the counter reaches a threshold sl-maxNumConsecutiveDTX for a carrier, the TX UE 310 detects carrier failure for that carrier. On the other hand, in response to detecting that PSFCH reception is detected on the PSFCH reception occasion, the counter is set to zero. In response to detecting or declaring carrier failure for a carrier, the TX UE 310 removes or releases the carrier. The carrier selection or reelection can be triggered. In some examples, this carrier can be released via PC5 RRC reconfiguration.

In some examples, in response to detecting the carrier failure, the TX UE 320 determines to cancel the carrier failure or determines that the carrier is recovered from the failure if the CBR of the carrier is lower than or below a configured CBR threshold. The CBR threshold can be configured by the network.

In some examples, a UE using new technology (e.g., Release 18 technology) needs to communicate with a UE using legacy technology (e.g., technology with release smaller than 18, Release 16, Release 17 technology). The new technology provide Carrier Aggregation (CA) mechanism, in which two or more carriers can be used to transmit and receive data. The legacy technology can only use single carrier (e.g., a specific legacy carrier). e.g., e.g., A TX profile of the TX UE 320 can be configured for each service type to allow the TX UE 320 to determine whether the RX UE 310 uses multiple carriers (e.g., CA) or a single carrier. In some examples, the TX profile indicates that the service type is backward compatible or backward incompatible. In some examples, the TX profile includes indication for at least one of backward compatible or backward incompatible. Backward compatible indicates that the RX UE 310 uses legacy technology and can use only a single carrier. Backward compatible indicates that the RX UE 310 uses new technology and can use multiple carriers or CA.

For broadcast or groupcast, the higher layer (e.g., V2X layer) maintains a list of all service types (e.g., activated service types and/or service types in which the UE is interested for reception) for a given destination Layer-2 ID and determines the TX profile available to be mapped for the respective service type based on the configuration.

Whenever the list of the service types for a given destination Layer-2 ID changes, the higher layer updates the AS layer for the NR TX Profiles information. Whenever the list of the service types for a given QoS flow identified by the QoS flow changes, the layer updates the AS layer for the TX Profiles information.

The higher layer determines whether and how to provide the TX Profiles for the given destination Layer-2 ID to the AS layer in response to at least one of following is met: 1) all the V2X service types have mapped NR TX Profiles, the V2X layer provides all the mapped NR TX profiles to the AS layer for the given destination Layer-2 ID, e.g., when providing other information such as the destination Layer-2 ID, PC5 QOS parameters; or 2) any of the V2X service types does not have mapped NR Tx profile, the V2X layer does not provide any NR TX profile to the AS layer for the given destination Layer-2 ID, e.g., when providing other information such as the destination Layer-2 ID, PC5 QOS parameters.

The higher layer determines whether and how to provide the TX profiles for the given QOS flow identified by QoS flow ID to the AS layer in response to at least one of following is met 1) all the service types have mapped TX Profiles, the higher layer provides all the mapped Tx Profiles to the AS layer for the given QoS flow, e.g., when providing other information such as the destination Layer-2 ID, PC5 QoS parameters; 2) at least one the service type have mapped Tx profile indicating backward compatible, the higher layer provides all the mapped TX Profiles to the AS layer for the given QoS flow, e.g., when providing other information such as the destination Layer-2 ID, PC5 QoS parameters; 3) If any of the service types does not have mapped TX profile, the higher layer does not provide any NR Tx profile to the AS layer for the given QoS flow, e.g., when providing other information such as the destination Layer-2 ID, PC5 QoS parameters.

In some examples, in response to determining that carrier selection or reselection is triggered for a Logical Channel (LCH), the TX UE 320 can select at least a legacy carrier upon determining that the radio bearer having the LCH or LCH is backward compatible. The TX UE 320 triggers carrier selection or reselection for a logical channel.

In response to determining that carrier selection or reselection is triggered for a logical channel belonging to a radio bearer, the TX UE 320 selects at least legacy carrier if at least one service type mapped to the radio bearer has TX profile indicating backward compatibility.

In some arrangements, the backward compatibility (e.g., TX profile) is configured for each service type. Different service types can be mapped to a same QoS flow. Different QoS flows can be mapped to a same radio bearer. Each radio bearer has one or more LCHs. The QoS flow or service type mapped to a radio bearer is mapped to LCH belonging to the radio bearer.

In some examples, Object-T can be a QoS flow, radio bearer, logical channel.

In some arrangements, no associated TX profile refers to backward compatibility. In some arrangements, the TX UE 320 determines that the Object-T to be backward compatible in response to determining at least one of at least one of service type mapped to this Object-T having at least one of: 1) TX profile indicating backward compatibility or 2) not associated to a TX profile.

In some arrangements, no associated TX profile refers to backward incompatibility. In some arrangements, the TX UE 320 determines that the Object-T to be backward compatible in response to determining that at least one of service type mapped to this Object-T have TX profile indicating backward compatibility.

In some arrangements, no associated TX profile refers to backward compatible. In some arrangements, the TX UE 320 determines that the Object-T is backward incompatible in response to determining that all service types mapped to this Object-T are each indicated to be backward incompatible.

In some arrangements, no associated TX profile means backward incompatible. In some arrangements, the TX UE 320 determines that the Object-T is backward incompatible in response to determining that all service types mapped to this Object-T are each indicated to be at least one of: 1)backward incompatible or 2) not associated to a TX profile.

In some arrangements, no associated TX profile means backward compatible. In some arrangements, the TX UE 320 determines that the radio bearer (or LCH) to be backward compatible in response to determining that at least one of QoS flows mapped to this radio bearer (or LCH) has at least one of: 1)TX profile indicating backward compatible or 2) is not associated to a TX profile.

In some arrangements, no associated TX profile means backward incompatible. In some arrangements, the TX UE 320 determines that the radio bearer (or LCH) to be backward compatible in response to determining that at least one of QoS flows mapped to this radio bearer (or LCH) has TX profile indicating backward compatible.

In some arrangements, no associated TX profile means backward compatible. In some arrangements, the TX UE 320 determines that the radio bearer (or LCH) is backward incompatible in response to determining that all QoS flows mapped to this radio bearer (or LCH) are each indicated to be backward incompatible.

In some arrangements, no associated TX profile means backward incompatible. In some arrangements, the TX UE 320 determines that the radio bearer (or LCH) is backward incompatible in response to determining that all QoS flows mapped to this radio bearer (or LCH) are each indicated to be at least one of: 1) backward incompatible or 2) are not associated to a TX profile.

In some arrangements, to make network knows the backward compatibility, the D2D communication information reported from UE to network includes: QoS flow ID, service type mapped to the QoS flow identified by the QoS flow ID, TX profile associated to the service type, backward compatibility value(e.g., backward compatible, backward incompatible) of the QoS flow identified by the QoS flow ID, requirement of legacy carrier for the QoS flow identified by the QOS flow ID.

In some arrangements, network may broadcast two carrier list. The first carrier list includes legacy carrier(the carrier for single carrier operation). The second carrier list includes carriers for multiple carrier operation. In response to the legacy carrier is included in D2D communication information, network should at least configure the resource on legacy carrier to UE.

In some arrangements, after a UE (e.g., the TX UE 320) obtains a COT in response to successfully performing LBT, in response to determining that no transmission is performed within the COT, the UE can lose the obtained COT given that the idle channel can be detected by other UEs. To address this issue. the UE can select a MCSt resource having one or more transmission slots. For example, following four slots is a MCSt resource. FIG. 5 is a diagram illustrating an example MCSt 501 resource with multiple slots 510, 520, 530, and 540 and an example MCSt 502 resource with multiple slots 550, 560, 570, and 580.

In some arrangements, for initial transmission resource selection, the TX UE 320 selects a MCSt resource (e.g., the MCSt 501), each slot (e.g., each of the slots 510, 520, 530, and 540) within the MCSt resource is used by the TX UE 320 for initial transmission in the D2D communication with the RX UE 310. In some arrangements, for retransmission resource selection, the TX UE 320 a MCSt resource (e.g., the MCSt 502), each slot (e.g., each of the slots 550, 560, 570, and 580) within the MCSt resource is used by the TX UE 320 for retransmission in the D2D communication with the RX UE 310. In some arrangements, a second MCSt resource 502 is selected by the TX UE 320 for retransmission of transmissions previously transmitted using a first MCSt resource 501.

In some arrangements, the first slot 550 in the second MCSt resource 502 is used by the TX UE 320 for retransmission of the first slot 510 in the first MCSt resource 501. The second slot 560 in the second MCSt resource 502 is for retransmission of a second slot 520 in the first MCSt resource 501, and so on. That is, an n^{th} slot in the second MCSt resource 502 is used to retransmit the transmission previously transmitted using an n^{th} slot in the first MCSt resource 501.

In some arrangements, each slot within the second MCSt resource 502 is for retransmitting the transmission in any slot in the first MCSt 501.

In some arrangements, the association or mapping between an initial transmission slot in the first MCSt resource 501 and a retransmission slot in the second MCSt resource 502 is determined using a state of the initial slot. For example, the first slot 550 in the second MCSt resource 502 can be used by the TX UE 320 for retransmitting the transmission in a first slot on which the retransmission is needed within the first MCSt 501. For example, the second slot 560 in the second MCSt resource 502 can be used by the TX UE 320 for retransmitting the transmission in a second slot on which the retransmission is needed within the first MCSt 501. That is, an n^{th} slot in the second MCSt resource 502 is used to retransmit the transmission previously transmitted using an n^{th} slot on which the retransmission is needed in the first MCSt resource 501.

In some arrangements, in response to the TX UE 320 selecting a MCSt resource, the TX UE 320 uses all the single-slot resources of the MCSt resource.

In some arrangements, the TX UE 320 selects a MCSt resource for transmitting a single transmission, e.g., a single Media Access Control (MAC) Packet Data Unit (PDU) or a Transport Block (TB). A Hybrid Automatic Repeat Request (HARQ) attribute of the MAC PDU is HARQ-enabled. In some examples, the TX UE 320 flushes or clears the HARQ buffer and flush the following retransmission resource in response to receiving a HARQ ACK/positive acknowledgement from a peer UE.

FIG. 6 is a diagram illustrating an example MCSt 600 resource with multiple slots 610, 620, 630, 640, 650, 660, 670, and 680. In some examples, the TX UE 320 uses slots 610, 630, 650, and 670 are Physical Sidelink Shared Channel (PSSCH) resources or are used to transmit a PSSCH. The TX UE 320 uses slots 620, 640, 660, and 680 are HARQ feedback resources or are used to receive HARQ feedback, e.g., Physical Sidelink Feedback Channel (PSFCH). That is, slot 620 is a feedback resource for the slot 610, slot 640 is a feedback resource for the slot 630, slot 660 is a feedback resource for the slot 650, slot 680 is a feedback resource for the slot 670. The TX UE 320 is configured to transmit a single TB in each of the slots 610, 630, 650, and 670. In response to determining that a positive feedback is first received on slot 620 (providing feedback for the slot 610), the TX UE 320 flushes the remaining resources 630, 650, and 670.

In some arrangements, the TX UE 320 selects a MCSt resource for transmitting multiple MAC PDUs or TBs. The HARQ attribute of the MAC PDU is HARQ-enabled. In some examples, the TX UE 320 UE flushes or clears the HARQ buffer and flush the following retransmission resource in response to receiving a HARQ ACK/positive acknowledgement from a peer UE. The MAC PDU or TB is stored in the HARQ buffer. If HARQ buffer is flushed, the MAC PDU will be discard and cannot be re-transmitted.

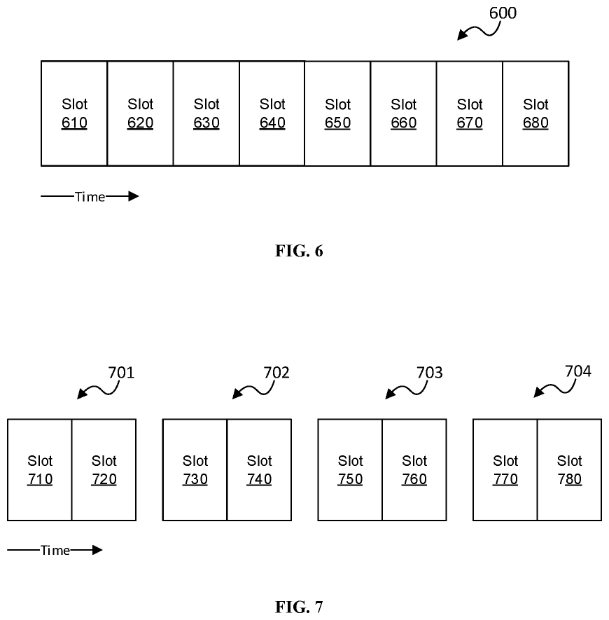

FIG. 7 is a diagram illustrating an example MCSt 701 resource with multiple slots 710 and 720, an example MCSt 702 resource with multiple slots 730 and 740, an example MCSt 703 resource with multiple slots 750 and 760, and an example MCSt 704 resource with multiple slots 770 and 780. In some examples, the TX UE 320 uses slots 710, 730, 750, and 770 for transmitting a first MAC PDU and uses slots 720, 740, 760, and 780 for transmitting a second MAC PDU. For example, the TX UE 320 transmits the first MAC PDU on slot 710, transmits a second MAC PDU on slot 720, and receives positive acknowledgement(e.g., HARQ ACK) for first MAC PDU and negative acknowledgement (e.g., HARQ NACK) of the second MAC PDU. In response, the TX UE 320 flushes slots 730, 750, and 770 and flushes the and HARQ buffer of first MAC PDU. Therefore, in the examples in which the TX UE 320 needs to use all the single-slot resources of a MCSt resource, the corresponding resource and HARQ buffer are not flushed.

In some arrangements, the TX UE 320 clears the transmission resource in response to at least one of (1) a positive acknowledgement to this transmission of the MAC PDU has been received and the transmission resource of this MAC PDU is not the resource within a MCSt resource; or (2) the transmission resource of this MAC PDU is a resource within a MCSt resource, MCSt resource is used for transmission of multiple MAC PDUs, and the next transmission of all MAC PDUs within the same MCSt resource is not required. The TX UE 320 clearing the transmission resource includes clearing a PSCCH duration and a PSSCH duration corresponding to a retransmission of the MAC PDU from the sidelink grant.

In some arrangements, the TX UE 320 determines that the next transmission of MAC PDU is not required (e.g., current transmission is the last transmission) in response to determining at least one of (1) a number of HARQ retransmissions selected by a MAC entity has been reached; (2) a positive acknowledgement to a transmission of the MAC PDU has been received; or (3) a negative-only acknowledgement is enabled in the Channel-State Information (SCI) and no negative acknowledgement has been received for the transmission of the MAC PDU. In some examples, the MAC entity determines that this transmission corresponds to the last transmission of the MAC PDU for sidelink resource allocation mode 2.

In some arrangements, the TX UE 320 flushes a HARQ buffer where MAC PDU is stored in response to at least one of (1) a positive acknowledgement to the transmission of the MAC PDU has been received and the transmission resource of this MAC PDU is not a resource within a MCSt resource; or (2) the transmission resource of this MAC PDU is a resource within a MCSt resource, the MCSt resource is used for transmission of multiple MAC PDUs, and the next transmission of all MAC PDUs within the same MCSt resource is not needed.

In some arrangement, one MAC PDU is one TB.

With respect to FIG. 7, each MCSt resource 701, 702, 703, or 704 contains two single-slot resources as shown. In some examples, resources 710, 730, 750, and 770 are used by the TX UE 320 for transmission of a first MAC PDU, and resources 720, 740, 760, and 780 are used by the TX UE 320 for transmission of a second MAC PDU. In the examples in which the TX UE 320 transmits the first MAC PDU on slot 710, transmits the second MAC PDU on slot 720, and receives positive acknowledgement (e.g., HARQ ACK) for first MAC PDU and negative acknowledgement (e.g., HARQ NACK) of the second MAC PDU. The TX UE 320 does not flush transmission resources 730, 750, and 770 and does not flush HARQ buffer of first MAC PDU.

In some examples, the TX UE 320 transmits the first MAC PDU on slot 710, transmits the second MAC PDU on slot 720, and receives positive acknowledgement (e.g., HARQ ACK) for first MAC PDU and positive acknowledgement (e.g., HARQ ACK) for second MAC PDU. In such examples, the TX UE 320 flushes the transmission resource 730, 750, 770 and flushes the HARQ buffer of first MAC PDU. The TX UE 320 flushes the transmission resource 740, 760, and 780 and flushes HARQ buffer of the second MAC PDU.

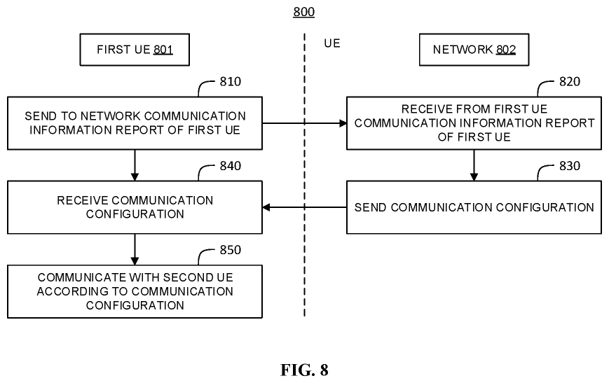

FIG. 8 is a flowchart diagram illustrating an example method 800 for providing communication configuration, according to various arrangements. The method 800 can be performed by a first UE 801 (e.g., the TX UE 320) and a network 802 (e.g., the network 330).

At 810, the first UE 801 sends to the network 802 (e.g., the BS 102) communication information report of the first UE 801. At 820, the network 802 receives from the first UE 801 the communication information report of the first UE 801. At 830, the network 802 sends communication configuration to the first UE 801. At 840, the first UE 801 receives the communication configuration from the network 802. At 850, the first UE 801 communicates with a second UE (e.g., the RX UE 310) using the communication configuration.

In some examples, the communication information report includes D2D communication information for D2D communication between the first UE 801 and the second UE. The communication configuration includes D2D communication configuration for the D2D communication between the first UE 801 and the second UE. In some examples, communicating with the second UE includes sending, by the first UE 801, the D2D communication to the second UE.

In some examples, the communication information report includes a transmission profile, a service type and a QoS flow ID, D2D frequency associated to the QoS flow identified by the QoS flow ID. In some examples, the transmission profile indicates whether the QoS flow identified by the QoS flow ID or the service type mapped to the QoS flow identified by the QoS flow ID is backward compatible or backward incompatible.

In some examples, the method 800 further include, determining, by the first UE 801, that a trigger condition for providing a transmission profile of a Quality of Service (QOS) flow of the first UE 801 is met. In some examples, the trigger condition includes determining that a last transmission of a D2D communication information excludes a QoS flow ID and a frequency corresponding to the QoS flow ID. In some examples, the trigger condition includes determining that at least one upper layer configures the first UE 801 to receive a sidelink communication on a frequency included in a second carrier list (e.g., sl-FreqInfoListSizeExt) in a SIB of a PCell and determining that since a last time that the first UE 801 transmitted a D2D communication information, the first UE 801 has connected to the PCell providing the SIB that does not include the frequency information list.

In some examples, the communication information report is sent by the first UE 801 to a CU (e.g., the CU 420) of the network 802. The communication configuration is received by the first UE 801 from the CU of the network 802. The communication configuration includes an RLC bearer configuration associated to an RB. The first UE 801 sends the RLC bearer configuration of the RB to second UE. The first UE 801 communicates with the second UE according to the RLC bearer configuration of the RB. In some examples, the CU sends an RB establish request to a DU (e.g., the DU 410). The establish request includes duplication configuration. The DU sends an RB establish (or setup or modification) response to the CU. The establish (or setup or modification) response includes the RLC bearer configuration.

In some examples, the duplication configuration includes at least one of an indication indicating whether duplication is enabled or disabled or an indication indicating whether duplication is configured or not configured. In some examples, the DU setups two RLC bearer for one radio bearer in response to receiving the duplication configuration from the CU in response to determining that the duplication configuration indicates that duplication is enabled or configured.

In some examples, the DU releases the additional RLC bearer (e.g., a second RLC bearer) for one radio bearer in response to receiving the duplication configuration from the CU in response to determining that the duplication configuration indicates that duplication is disabled or not configured.

In some examples, the RLC bearer configuration includes at least one of two RLC bearer configurations associated to one radio bearer, allowed carrier list including carriers on which data of the RLC bearer is allowed to be transmitted. In some examples, the method 800 further includes establishing, by the first UE 801, two RLC bearers for a radio bearer with the first UE 801.

In some examples, the method 800 further includes clearing, by the first UE 801, a first transmission resource for a transmission in response to determining that a positive acknowledgement to a second transmission resource of the transmission has been received by the first UE 801. The second transmission resource of the transmission is not a resource within a MCSt resource.

In some examples, the method 800 further includes clearing, by the first UE 801, a first transmission resource for a transmission in response to determining that a second transmission resource of the transmission is a resource within a MCSt resource, the MCSt resource is used for transmission of multiple transmissions, and a next transmission of all transmissions within the MCSt resource is not needed.

In some examples, the method 800 further includes clearing, by the first UE 801, a feedback buffer (e.g., HARQ buffer) for including at least one resource for receiving feedback for a transmission in response to determining that a positive acknowledgement to a transmission resource of the transmission has been received by the first UE 801. The transmission resource of the transmission is not a resource within a MCSt resource.

In some examples, the method 800 further includes clearing, by the first UE 801, a HARQ buffer in response to determining that a transmission resource of the transmission is a resource within a MCSt resource, the MCSt resource is used for transmission of multiple transmissions, and a next transmission of all transmissions within the MCSt resource is not needed.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
sending, by a first wireless communication device to a network, a communication information report of the first wireless communication device, wherein the communication information report comprises a transmission profile that indicates whether a quality of service QoS flow identified by a QoS flow identifier (ID) is backward compatible or backward incompatible;
receiving, by the first wireless communication device from the network, a communication configuration; and
communicating, by the first wireless communication device with a second wireless communication device according to the communication configuration.

2. The wireless communication method of claim 1, wherein the communication information report further comprises the QoS flow ID, and a device-to-device (D2D) frequency associated to the QoS flow identified by the QoS flow ID.

3. The wireless communication method of claim 1, wherein
the communication information report is sent by the first wireless communication device to a Centralized Unit (CU) of the network;
the communication configuration is received by the first wireless communication device from the CU of the network; and
the communication configuration comprises a Radio Link Control (RLC) bearer configuration associated to a Radio Bearer (RB).

4. The wireless communication method of claim 1, wherein
the first wireless communication device sends a RLC bearer configuration of a RB to the second wireless communication device; and
the first wireless communication device communicates with the second wireless communication device according to the RLC bearer configuration of the RB.

5. The wireless communication method of claim 1, further comprising:
receiving, by the first wireless communication device, a first carrier list and a second carrier list from the network,
wherein the first carrier list comprises a legacy carrier for single carrier operation, and the second carrier list comprises carriers for multiple carrier operation.

6. The wireless communication method of claim 5, further comprising:
selecting, by the first wireless communication device, at least the legacy carrier in response to the transmission profile indicating the QoS flow is backward compatible.

7. The wireless communication method of claim 1, further comprising:
determining, by the first wireless communication device, the QoS flow to be backward compatible, in response to there being no associated transmission profile.

8. A wireless communication method, comprising:
receiving, by a network from a first wireless communication device, a communication information report of the first wireless communication device, wherein the communication information report comprises a transmission profile that indicates whether a quality of service QoS flow identified by a QoS flow identifier (ID) is backward compatible or backward incompatible;
sending, by the network to the first wireless communication device, a communication configuration; and
causing the first wireless communication device to communicate with a second wireless communication device according to the communication configuration.

9. The wireless communication method of claim 8, wherein the communication information report further comprises the QoS flow ID, and a device-to-device (D2D) frequency associated to the QoS flow identified by the QoS flow ID.

10. The wireless communication method of claim 8, wherein
the communication information report is received by a Centralized Unit (CU) of the network, from the first wireless communication device;
the communication configuration is sent by the CU of the network to the first wireless communication device; and
the communication configuration comprises a Radio Link Control (RLC) bearer configuration associated to a Radio Bearer (RB).

11. The wireless communication method of claim 10, wherein
the CU sends an RB modify request to a Distributed Unit (DU), wherein the RB modify request comprises duplication configuration; and
the CU receives an RB modify response from the DU, wherein the RB modify response comprises the RLC bearer configuration.

12. The wireless communication method of claim 11, wherein the DU setups two RLC configurations for one radio bearer in response to the duplication configuration from the CU indicating that duplication is enabled.

13. The wireless communication method of claim 11, wherein the DU releases an additional RLC bearer for one radio bearer in response to the duplication configuration from the CU indicating that duplication is disabled.

14. The wireless communication method of claim 11, wherein the duplication configuration comprises a first value indicating that duplication is enabled or comprises a second value indicating that duplication is disabled; or
wherein the duplication configuration is used for packet data convergence protocol (PDCP) duplication for device-to-device (D2D) communication.

15. The wireless communication method of claim 8, further comprising:
sending, by the network to the first wireless communication device, a first carrier list and a second carrier list,
wherein the first carrier list comprises a legacy carrier for single carrier operation, and the second carrier list comprises carriers for multiple carrier operation.

16. The wireless communication method of claim 15, wherein at least the legacy carrier is selected in response to the transmission profile indicating the QoS flow is backward compatible.

17. The wireless communication method of claim 8, wherein the QoS flow is determined to be backward compatible, in response to there being no associated transmission profile.

18. A first wireless communication device, comprising:
a transceiver configured to:
send, to a network, a communication information report of the first wireless communication device, wherein the communication information report comprises a transmission profile that indicates whether a quality of service QoS flow identified by a QoS flow identifier (ID) is backward compatible or backward incompatible;
receive, from the network, a communication configuration; and
communicate with a second wireless communication device according to the communication configuration.

19. A network, comprising:
a transceiver configured to:
receive, from a first wireless communication device, a communication information report of the first wireless communication device, wherein the communication information report comprises a transmission profile that indicates whether a quality of service QoS flow identified by a QoS flow identifier (ID) is backward compatible or backward incompatible; and
send, to the first wireless communication device, a communication configuration, which causes the first wireless communication device to communicate with a second wireless communication device according to the communication configuration.
